(19) United States
(12) Patent Application Publication
(10) Pub. No.: US 2015/0085597 A1
(43) Pub. Date: Mar. 26, 2015

(54) SINGLE-SCREW EXTRUDER WITH GROOVED INFEED SYSTEM

(71) Applicant: KRAUSSMAFFEI TECHNOLOGIES GMBH, MÜNCHEN (DE)

(72) Inventors: Florian Johannes Schneider, Bergen (DE); Jens Pape, Porta Westfalica (DE)

(73) Assignee: KRAUSSMAFFEI TECHNOLOGIES GMBH, MÜNCHEN (DE)

(21) Appl. No.: 14/394,407

(22) PCT Filed: Apr. 18, 2013
(86) PCT No.: PCT/EP2013/058059

§ 371 Date: Oct. 14, 2014

(30) Foreign Application Priority Data
Apr. 21, 2012 (DE) 10 2012 008 023.9

(51) Int. Cl. B29C 47/60; B01F 7/00

(52) U.S. Cl. CPC B29C 47/60; B01F 7/00
USPC 366/88

(57) ABSTRACT

A single-screw extruder includes a grooved infeed system, a cylinder, and an extruder screw rotatably supported in the cylinder. The extruder screw has a softening zone, a main plasticizing zone, and a post-plasticizing zone and is at least double-threaded in the area of the main plasticizing zone. The cylinder at least partially has at least one groove extending substantially in the longitudinal direction in the region of the main plasticizing zone.

The present invention pertains to a single-screw extruder with a grooved infeed system, a cylinder and an extruder screw that is rotatably supported in the cylinder, wherein the extruder screw features a softening zone, a main plasticizing zone or main melting zone and a post-plasticizing zone or homogenizing or residual melting zone and is realized in the form of an at least double-channel screw in the area of the main plasticizing zone.

Single-screw extruders are subject to a perpetual demand for increased productivity. High throughputs should be achieved with low delivery temperatures and high quality of the molten material. Two options are available for increasing the throughput: increasing the specific throughput, e.g., by utilizing grooved infeed systems and/or increasing the speed. Both measures are associated with a shorter residence time of the molten material in the extruder. In order to compensate these shorter residence times and to maintain the melting power, the partial resistances were increased by narrowing the overflow gaps. In addition to the increased pressure loss, however, this measure also has the disadvantages of increased wear and reduced energy efficiency.

The present invention is based on the objective of developing a single-screw extruder that makes it possible to achieve an improved melting effect and to simultaneously increase the throughput, reduce the temperature of the molten material and improve the pressure build-up capability.

This objective is attained by means of a single-screw extruder with the characteristics of Claim 1. Advantageous embodiments are described in the dependent claims.

The invention is based on the notion of operating a polygonal screw with a grooved infeed system, as well as in an at least partially grooved cylinder. Polygonal screws may consist, for example, of Energy-Transfer screws (ET screws) and Wave screws. These screws have an undulating channel depth profile and offset thread areas, over which the molten material flows in front of a wave crest, i.e. the channel depth minimum. In wave screws, the same thread is always offset such that the molten material overflows in different directions whereas the threads of ET screws are alternately offset in front of each wave crest such that the molten material always overflows in the same direction. The polygonal screw features at least two channels in the area of the main plasticizing zone, wherein the channel depth varies in an undulating fashion in each channel and the wave crests are offset from channel to channel. According to the invention, at least a section of the cylinder in the area of the main plasticizing zone features at least one groove that essentially extends in the longitudinal direction, i.e. axially or spirally, but not only radially.

In an advantageous embodiment, the minimum channel depth or channel height in the area of the main plasticizing zone decreases in the processing direction from the wave crest of one channel to the wave crest of the other channel such that the relative compression, i.e. the ratio between the channel depths of two successive wave crests, remains approximately constant. Successive wave crests are the wave crest of one channel and the following wave crest of the adjacent channel. In contrast, the channel depth in the trough areas, i.e. the channel depth maximums, increases from trough to trough along the screw in order to increase the residence time of the plastic material. Longer residence times favorably affect temperature equalization processes between cold and warm material fractions in the raw molten material.

It is furthermore advantageous that at least one screw thread is in front of each wave crest offset to form a gap, i.e. cut lower than the remaining outside diameter of the screw, and that the resulting gap height corresponds to the channel depth of the respective following wave crest. In an ET screw, this means that each screw thread is on the active channel side offset to form a gap in front of each wave crest, wherein the gap height respectively corresponds to the channel depth of the following wave crest. The active channel side is the channel side, from which the molten material flows to the passive channel side over the offset thread. In a wave screw, the offset thread may be stepped or continuously offset. In a stepped thread, the gap height respectively corresponds to the channel depth of the following wave crest whereas the gap height on the following wave crest respectively corresponds to the channel depth of this following wave crest in a continuously offset thread.

In this context, it is particularly preferred that the length of the respectively offset thread area increases along the screw from wave crest to wave crest in the processing direction such that the surface area defined by the gap height and the gap length increases about 1 to 5%, particularly about 1 to 2%, in the processing direction. In this way, the decreasing channel depth in the area of the wave crests is compensated and the increased flow of the molten material over the thread is taken into account due to the increased surface area defined by the gap height and the gap length.

It is furthermore advantageous that the thread pitch in the main plasticizing zone is 1.3 D (non-dimensional pitch) because this thread pitch makes it possible to achieve the highest efficiency with respect to the material transport. On the active flank, the offset thread areas are advantageously provided with a 45° bevel over about 30 to 70 percent, preferably about 50 percent, of the thread width. This bevel accelerates the material and increases the energetically more effective expansional flow component.

The sections of increasing channel depth behind the wave crests are advantageously undercut, i.e. the channel depth once again quickly increases behind the crest, whereas the channel depth in front of the crest only decreases slowly. In other words, the sections of increasing channel depth behind a wave crest have a steeper flank than the sections of decreasing channel depth in front of a wave crest. In this way, unnecessary shearing is prevented and the material transport is improved.

According to a preferred enhancement, the screw is advantageously provided with additional groove-shaped recesses or so-called mixing pockets in sections of decreasing channel depth in front of a wave crest. The mixing pockets extend on the screw base parallel to the screw threads. The mixing pockets promote the mixing of solid material and molten material. A multi-row arrangement of such mixing pockets intensifies this positive effect.

It is furthermore advantageous that the depth profile and/or the width and/or the cross section of the groove are adapted to the screw profile. In a preferred embodiment, the groove depth has a local minimum in the area of a wave crest. In this way, the energy conversion or the melting power in the area of the wave crests can be controlled and a drainage effect of sorts for the residual solid fractions can be generated.

The inventive single-screw extruder has a much higher melting power than conventional systems, wherein the material overheating tendency is significantly reduced. Another economically advantageous aspect is the comparatively small space requirement of the inventive single-screw extruder. Furthermore, the inventive design makes it possible to significantly lower the pressure level in the cylinder such that the energy efficiency is decisively improved and a prolonged service life of the extruder can be expected.

Exemplary embodiments of the invention are described in greater detail below with reference to the drawings. In these drawings:

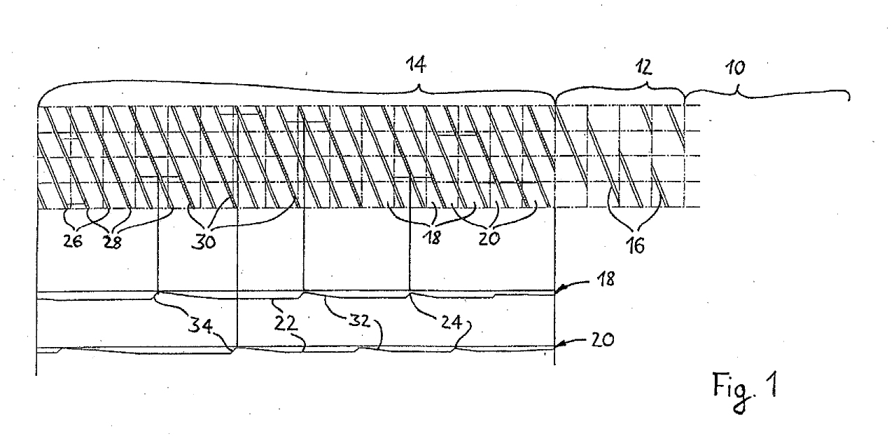

FIG. 1 shows a developed view with the channel depth profile of an extruder screw according to a first exemplary embodiment of the invention;

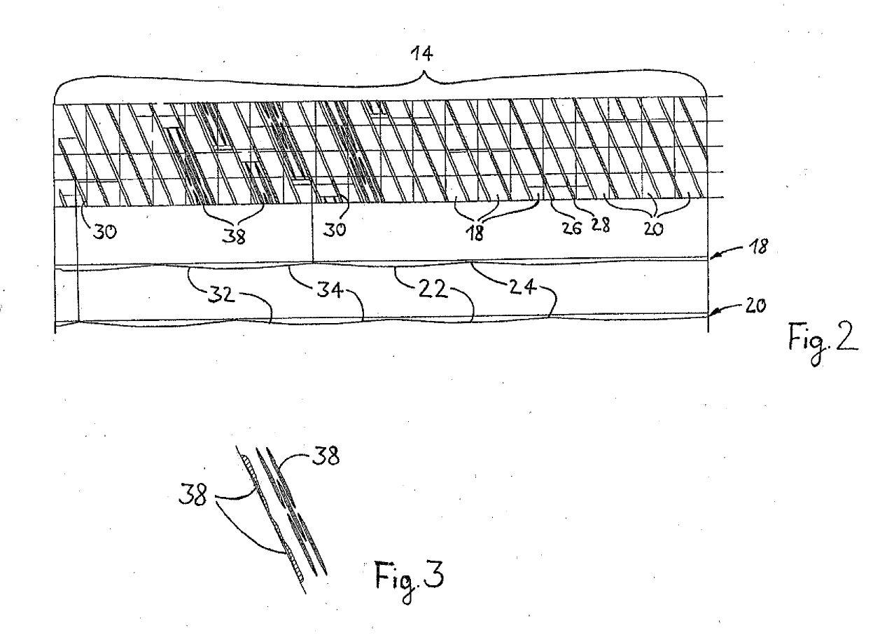

FIG. 2 shows a developed view with the channel depth profile of an extruder screw with mixing pockets according to a second exemplary embodiment of the invention, and

FIG. 3 shows an enlarged detail of the mixing pockets according to the second exemplary embodiment of the invention in FIG. 2.

The inventive single-screw extruder comprises a cylinder that is not illustrated in the figures and a polygonal screw that is rotatably supported in the cylinder. In the described exemplary embodiments, the polygonal screw is realized in the form of an Energy-Transfer screw as shown in FIGS. 1 and 2. In alternative embodiments, the polygonal screw may naturally also be realized in the form of a wave screw.

FIG. 1 shows a developed view with the channel depth profile of an extruder screw according to a first exemplary embodiment of the invention. Referred to the processing direction, the extruder screw comprises an infeed zone 10, a softening zone 12, a main plasticizing zone 14 and a not-shown post-plasticizing zone. According to FIG. 1, the softening zone 12 comprises short thread sections 16 that are arranged in an offset fashion and divide the still cold and hard solid bed several times. This results in a temperature increase in the solid material. It can therefore be deformed plastically

According to FIG. 1, the main plasticizing zone 14 features two channels 18, 20. The channel depths of the two channels 18, 20 change several times in an undulating fashion along the screw independently of one another. In this way, deep channel sections—wave troughs 22, flat channel sections—wave crests 24, as well as sections of decreasing channel depth 32 and sections of increasing channel depth 34, are produced. The wave troughs 22, as well as the sections of decreasing channel depth 32 and increasing channel depth 34, have a certain length whereas the wave crests 24 ideally have a local channel depth minimum as illustrated in FIG. 1 and do not extend over a longer distance. Between the channels 18, 20, the screw features threads 26, 28 that have the same constant pitch.

According to FIG. 1, the minimum channel depth on the wave crests 24 decreases from wave crest to wave crest in the region of the main plasticizing zone 14 such that the relative compression, i.e. the ratio between the channel depths of two successive wave crests 24, remains approximately constant. In contrast, the maximum channel depth in the wave troughs 22 increases from trough to trough. In this case, the channel depth and the channel width are dependent on the material transport capacity required for achieving the desired throughput.

On their active flank, the screw threads 26, 28 respectively feature offset areas—gaps 30—in front of the wave crests. In this case, the gap height corresponds to the channel depth of the following wave crest 24. According to FIG. 1, the length of the gaps 30 increases from gap to gap. Referred to the processing direction, the surface area defined by the gap height and the gap length increases 1 to 2 percent from gap to gap. On their active flank, the gaps are provided with a 45° bevel over 50 percent of the thread width. The bevel width corresponds to half the thread width.

According to the first exemplary embodiment, the main plasticizing zone has a thread pitch of 1.3 D (non-dimensional pitch).

According to the channel depth profile in FIG. 1, the sections of increasing channel depth 34 are undercut behind the wave crests 24, i.e. they have a steeper flank than the sections of decreasing channel depth 32 in front of the wave crests 24.

According to a second exemplary embodiment illustrated in FIG. 2, the screw features groove-shaped recesses—mixing pockets 38—in sections of decreasing channel depth 34. In the exemplary embodiment, several mixing pockets 38 respectively extend on the screw base parallel to one another and parallel to the screw threads 26, 28. According to FIG. 3, the mixing pockets are in this exemplary embodiment arranged offset to one another and respectively have a varying width and depth. For example, the mixing pockets in a central region have a greater depth and width, wherein their depth and width are reduced toward their ends such that they form a smooth transition to the inner cylinder wall and dead zones are prevented. In other respects, the design of the inventive extruder screw according to the second exemplary embodiment essentially corresponds to the first exemplary embodiment; identical elements are therefore identified by the same reference symbols.

In the area of the main plasticizing zone, the not-shown cylinder is provided with a groove in the inner cylinder wall. In this case, the depth profile of the groove is adapted to the profile of the polygonal screw. According to the exemplary embodiments, the groove depth has a local minimum in the area of a wave crest of the polygonal screw. In the present exemplary embodiments, the groove in the inner cylinder wall extends spirally over the entire length of the main plasticizing zone and has a rectangular cross section. However, the groove may also have other cross sections such as, e.g., semicircular, rectangular or triangular, particularly sawtooth-shaped, etc., and axially or spirally extend along the entire inner cylinder wall or only sections thereof. A combination of several designs would also be feasible.

A single-screw extruder according to the present invention therefore makes it possible to realize a higher throughput and to simultaneously improve the quality of the molten material.

### LIST OF REFERENCE SYMBOLS

10 Infeed zone

12 Softening zone

14 Main plasticizing zone

16 Thread section of softening zone

18 Channel 1

20 Channel 2

22 Wave trough

24 Wave crest

26 Screw thread 1

28 Screw thread 2

30 Gap

32 Section of decreasing channel depth

34 Section of increasing channel depth

38 Mixing pocket

1.-8. (canceled)

9. A single-screw extruder, comprising:
a grooved infeed system;
a cylinder having an inner cylinder wall; and
an extruder screw rotatably supported in the cylinder and comprising in a processing direction a softening zone, a main plasticizing zone, and a post-plasticizing zone, said extruder screw having in the area of the main plasticizing zone at least two channels which are defined by channel depths which respectively vary in an undulating fashion and by wave crests in offset relationship,
wherein the inner cylinder wall is provided in an area of the main plasticizing zone, at least partially, with at least one groove that essentially extends in a longitudinal direction,
wherein the extruder screw has at least one screw thread which in the area of the main plasticizing zone is offset to form in front of each wave crest a gap of a gap height which corresponds to a channel depth of a respectively following one of the wave crests.

10. The single-screw extruder of claim 9, wherein the extruder screw has a polygonal configuration and is constructed in the form of an Energy-Transfer screw, with each screw thread on an active thread side being offset to form in front of each wave crest in the area of the main plasticizing zone a gap of a gap height which corresponds to a channel depth of a respectively following one of the wave crests.

11. The single-screw extruder of claim 9, wherein the gap has a gap length which increases in the processing direction such that a surface area defined by the gap height and the gap length increases by 1 to 5 percent between two successive gaps.

12. The single-screw extruder of claim 9, wherein the gap has a gap length which increases in the processing direction such that a surface area defined by the gap height and the gap length increases by 1 to 2 percent between two successive gaps.

13. The single-screw extruder of claim 9, wherein sections of increasing channel depth behind a wave crest have a flank which is steeper than sections of decreasing channel depth in front of a wave crest.

14. The single-screw extruder of claim 10, wherein the polygonal screw includes in sections of decreasing channel depth in front of a wave crest groove-shaped recesses which extend parallel to the screw thread.

15. The single-screw extruder of claim 10, wherein a depth of the groove in the inner cylinder wall has a local minimum in an area of a wave crest of the polygonal screw.
